(19) United States
(12) Patent Application Publication
(10) Pub. No.: US 2019/0034890 A1
(43) Pub. Date: Jan. 31, 2019

(54) Web-based Non-Profit Fundraising and Consumer Marketing and Analytics System

(71) Applicant: MICHAEL CHRISTOPHER WALLACE, SAN DIEGO, CA (US)

(72) Inventor: MICHAEL CHRISTOPHER WALLACE, SAN DIEGO, CA (US)

(21) Appl. No.: 15/927,079

(22) Filed: Mar. 20, 2018

Related U.S. Application Data
(60) Provisional application No. 62/473,610, filed on Mar. 20, 2017.

(51) Int. Cl. G06Q 20/08; H04L 12/26

(52) U.S. Cl. CPC G06Q 20/085; H04L 43/106

(57) ABSTRACT

In an embodiment, a web-based non-profit fundraising and consumer marketing and analytics system is provided. In an embodiment, a web-based analytic system is provided. The system includes a message scheduler. The system further includes a donation stream, wherein the donation stream include a set of donations and wherein each donation of the donation stream is provided with a time stamp, and wherein the time stamp correlates with a scheduled message from the message scheduler.

### CLAIM OF PRIORITY

This application claims priority to U.S. Provisional entitled “Web-based Non-Profit Fundraising and Consumer Marketing and Analytics System.” with a Ser. No. of 62/473,610 and a filing date of Mar. 20, 2017.

### BACKGROUND OF THE INVENTION

### 1. Field of Invention

The present invention relates to the field of web-based fundraising and consumer marketing and analytics, and more specifically to a cloud based fundraising and consumer marketing and analytics system which 1) allows the user to generate campaign messaging in novel ways; 2) communicate with potential donors, either in-person, electronically or via broadcast; 3) capture and assemble data for analytical feedback based on responses to fundraising and marketing messages and; 4) allow the user to display data results in novel ways for analysis and learning.

### 2. Description of Related Art

The concept of non-profit fundraising is nothing new and may be conducted by such means as mail, email, broadcast, social media, events and in-person appeals. One of the most recognizable in-person fundraising campaigns is organized by the Girl Scouts of America, in which children fundraise for their local Troop by selling cookies. Many organizations appeal for contributions using mail and telemarketing. A growing number of fundraising efforts rely on email, social media and crowd funding. Appeals can include social, religious, political, environmental and other causes.

The goal of marketing is to change the consumer's behavior to purchase a product or service. It is therefore not surprising that the goal of fundraising is to change the consumer's behavior by inspiring them to make a donation or donate again. As such, a growing number of charitable organizations are relying more and more on techniques borrowed from consumer marketing, such as email and social media. Data mining and analytics are now important tools in the fundraiser's toolkit. Gathering data and analytics on the effectiveness of various types of appeals helps the organization maximize donations and reduce fundraising expense.

Like a good marketing campaign, appeals in a fundraising campaign are at least somewhat “scripted” or planned in advance. For example, public radio, which relies on donor contributions for funding, uses scheduled program breaks to ask listeners to make donations to support a service they rely on each day. Although the messages can be very short, the content and structure of the messages can be very important to how they are received. Messages that are similar may be received differently by different audiences, or there may be messages which are universally received by all audiences. Message content, message length, delivery, message structure and even specific phrases or words can all be important factors for the success of a fundraising campaign for public radio and other causes.

Based on the foregoing, there is a need in the art for a web-based fundraising and marketing analytics system which allows a user to schedule custom messages in an efficient way, and what might be further desired is a web-based fundraising system which provides users with analytical data based on how the messages are received by potential donors. Further, there is a need in the art for an analytics interface system which allows a user to customize data display for more effective learning.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a screenshot of the web-based fundraising system, according to an embodiment of the present invention;

FIG. 2 is a screenshot of the web-based fundraising system, according to an embodiment of the present invention;

FIG. 3 is a screenshot of the web-based fundraising system, according to an embodiment of the present invention;

FIG. 4 is a screenshot of the web-based fundraising system, according to an embodiment of the present invention;

FIG. 5 is a screenshot of the web-based fundraising system, according to an embodiment of the present invention;

FIG. 6 is a screenshot of the web-based fundraising system, according to an embodiment of the present invention;

FIG. 7 is a screenshot of the web-based fundraising system, according to an embodiment of the present invention;

FIG. 8 is a screenshot of the web-based fundraising system, according to an embodiment of the present invention;

FIG. 9 is a screenshot of the web-based fundraising system, according to an embodiment of the present invention;

FIG. 10 is a screenshot of the web-based fundraising system, according to an embodiment of the present invention;

FIG. 11 is a screenshot of the web-based fundraising system, according to an embodiment of the present invention; and

FIG. 12 is a screenshot of the web-based fundraising system, according to an embodiment of the present invention.

FIG. 13 is a diagram of a system according to an embodiment of the present invention.

FIG. 14 is a flow diagram according to an embodiment of the present invention.

### DETAILED DESCRIPTION OF PREFERRED EMBODIMENTS

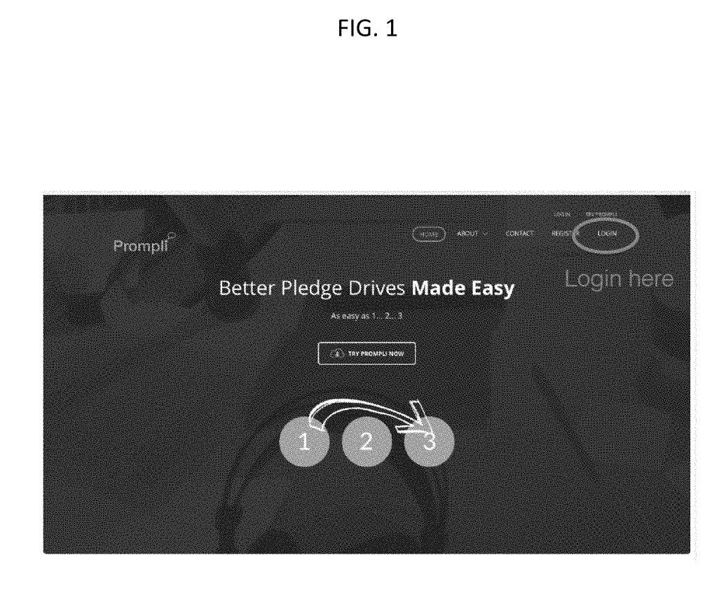

Preferred embodiments of the present invention and their advantages may be understood by referring to FIGS. 1-16, wherein like reference numerals refer to like elements.

In reference to FIG. 1, an embodiment of the present invention is shown. In the embodiment, a user is provided with a home screen and begins use of the system by signing in using a login name and a password.

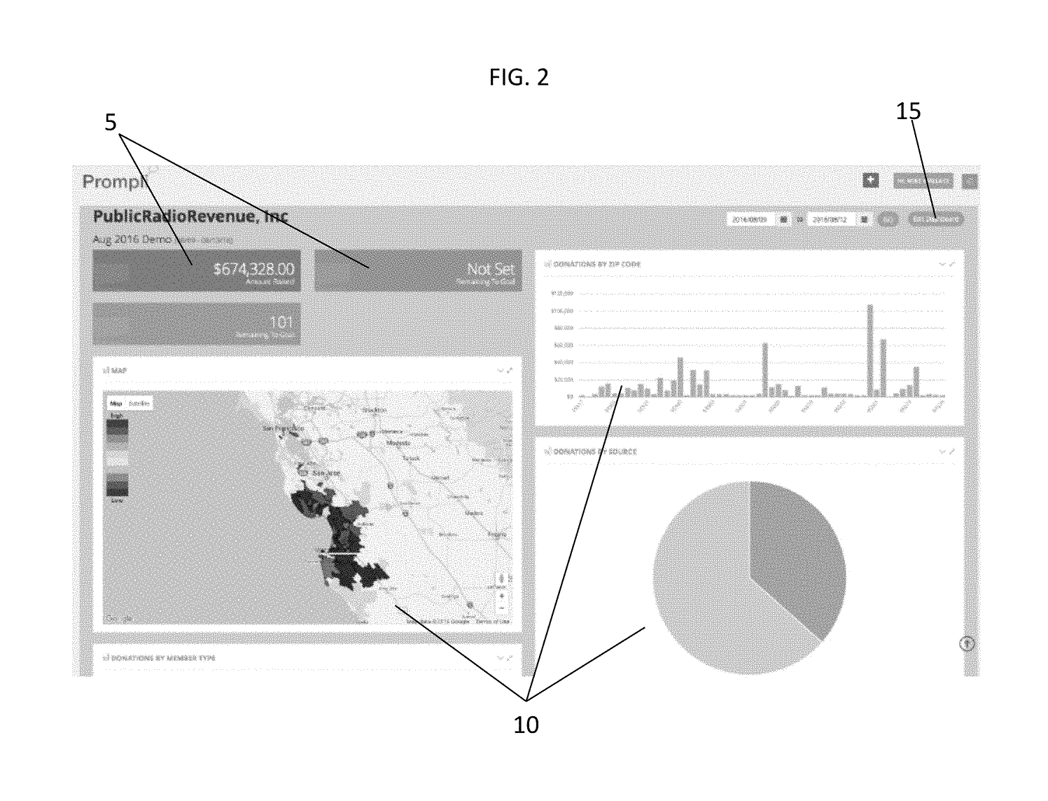

In reference to FIG. 2, upon logging in to the system, the user is provided with a dashboard. In the preferred embodiment, the dashboard provides the user with widgets 5 and charts 10 containing fundraising analytics for their campaign. The user is able to customize the dashboard by selecting the edit dashboard button 15.

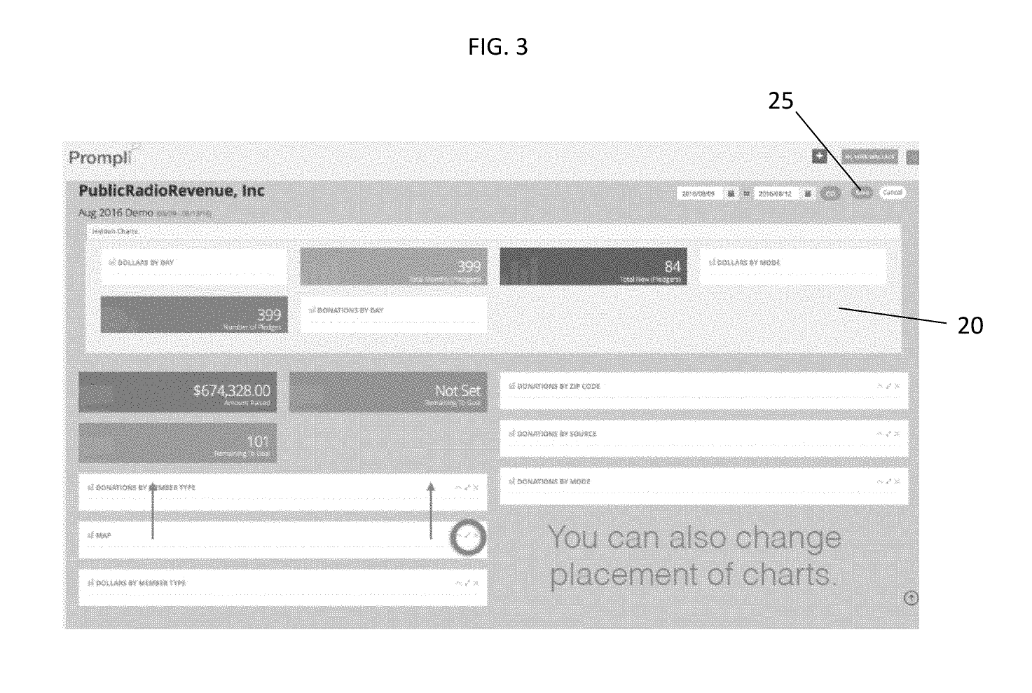

In the preferred embodiment, upon selecting the edit dashboard button 15, the user is provided with a dashboard editing. In reference to FIG. 3 the user is able to drag and drop widgets into their dashboard from the widget bin 20. The user is also able to change the placement and appearance of the charts on their dashboard. When the user is satisfied with the edits to the dashboard, they may save the configuration using the save button 25.

In a preferred embodiment of the present invention, widgets may be combined to provide to create custom widgets which include data fields which would normally be separated into two or more widgets. In the embodiment, attributes of the appearance of the widgets will combine when their data fields are combined. For example, a red widget displaying the total donation amount may be combined with a blue widget displaying the total number of donors. The resulting widget will be purple in color (combining the blue and red of the original widgets) and will display the total donation amount and number of donors, or combine the data to display the average donation per donor.

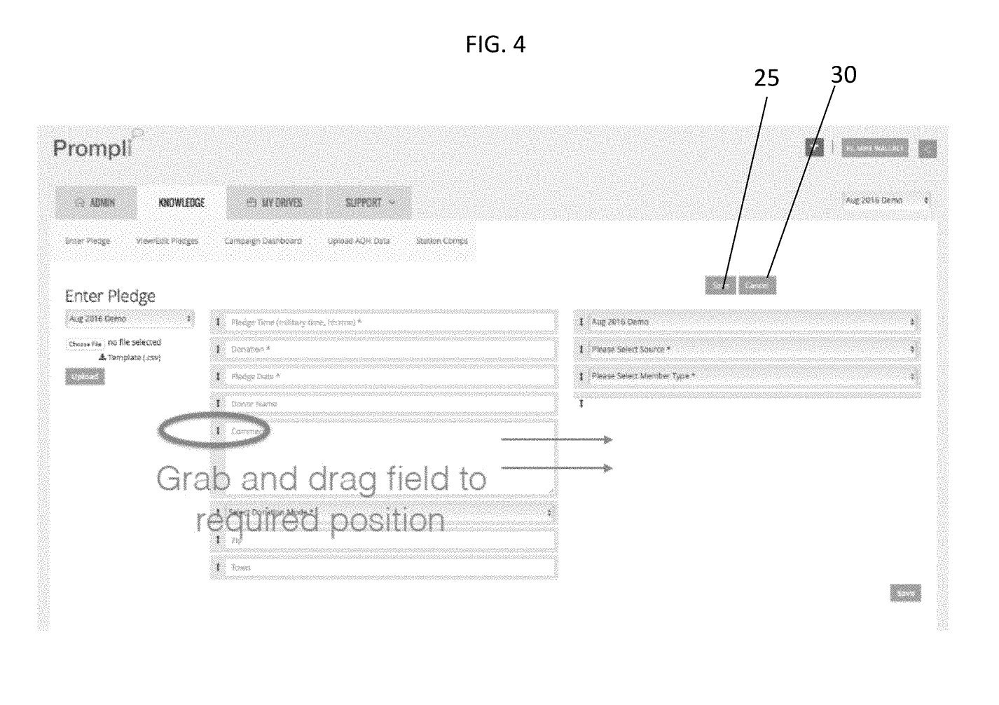

In reference to FIG. 4, a preferred embodiment of the pledge form edit page is shown. The pledge form edit page allows a user to edit the format and style of the pledge forms as they appear to potential donators. In the preferred embodiment, the data fields can be dragged and dropped into the desired position. After the edits are complete, the user may save the configuration using the save button 25. If the user wishes to discard the edits, they may select the cancel button 30 at any time. This feature might be especially useful when an organization prioritizes specific details regarding donors and contributions made.

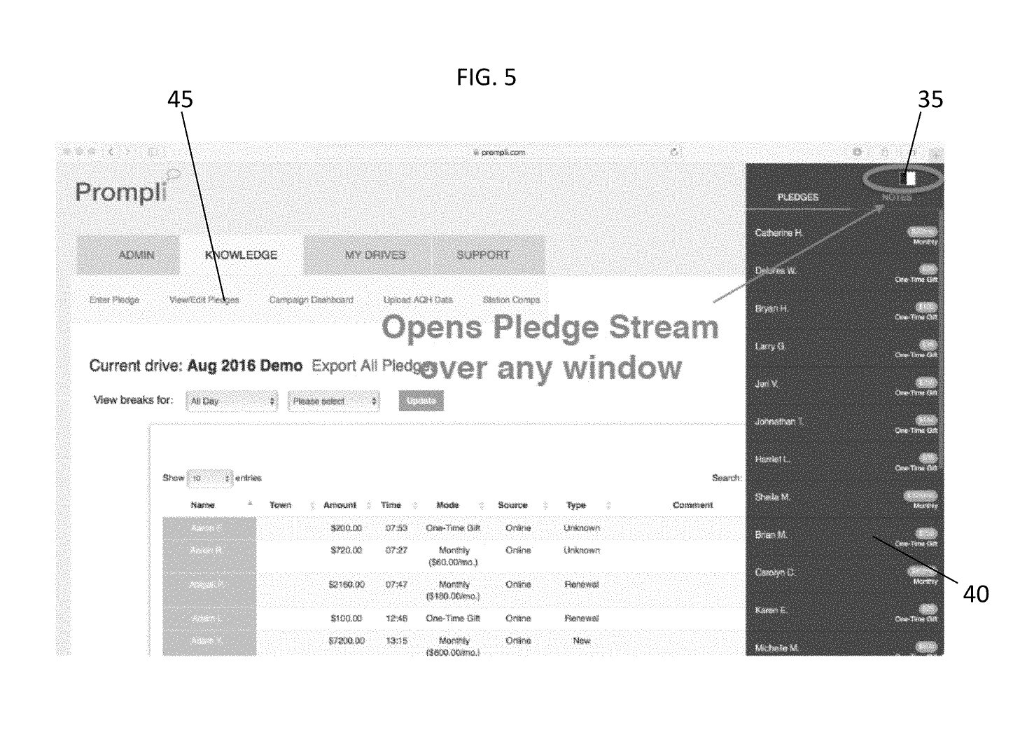

In reference to FIG. 5, a preferred embodiment of the fundraising system is shown, wherein the pledge stream 40 has been opened by selecting the pledge stream button 35. The pledge stream 40 displays updated information about donations and donors in a chronological format. The pledge stream 40 can be displayed over any window. A user can also access pledge/donor information by selecting the view/edit pledges tab 45. This will display the pledge dashboard for the user.

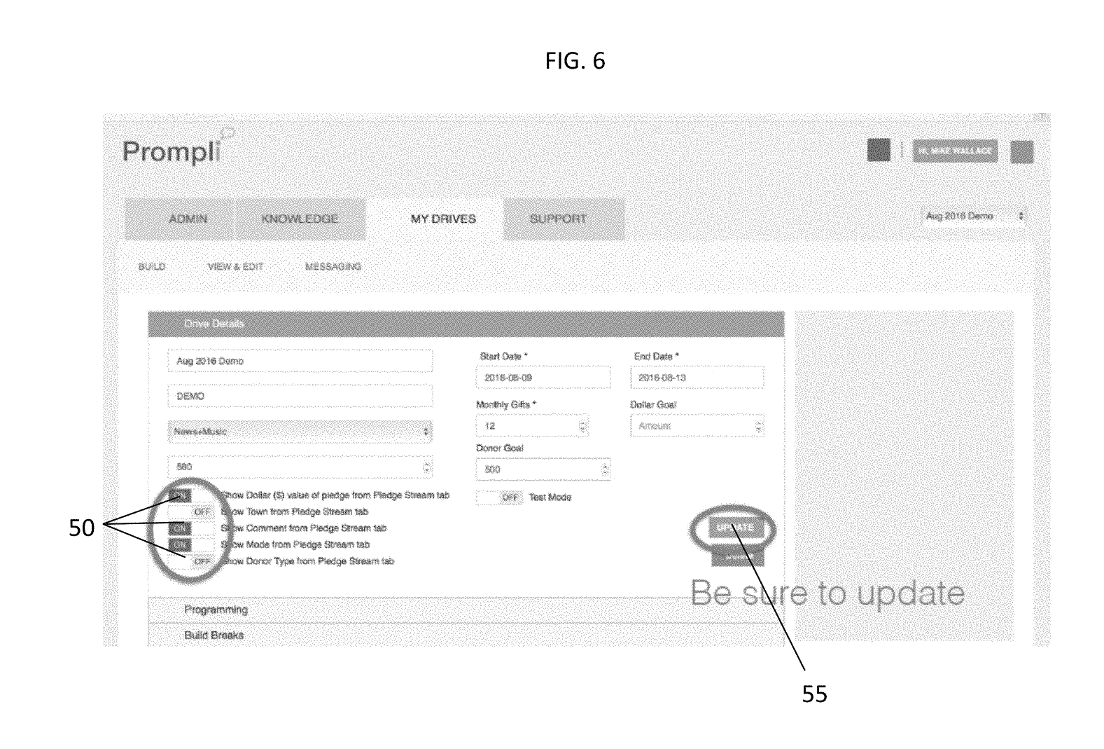

In reference to FIG. 6, a preferred embodiment of the drive details section is shown for a specific drive. The drive details section also provides toggle buttons 50 to allow a user to change what information is displayed in the pledge stream. Donor information, such as donation values, location of donors, comments from the donors, donor types, and donation mode are examples of the information users are able to toggle using the toggle buttons 50. After the preferred setting are selected, the user can select the update button 55 to save their preferred settings.

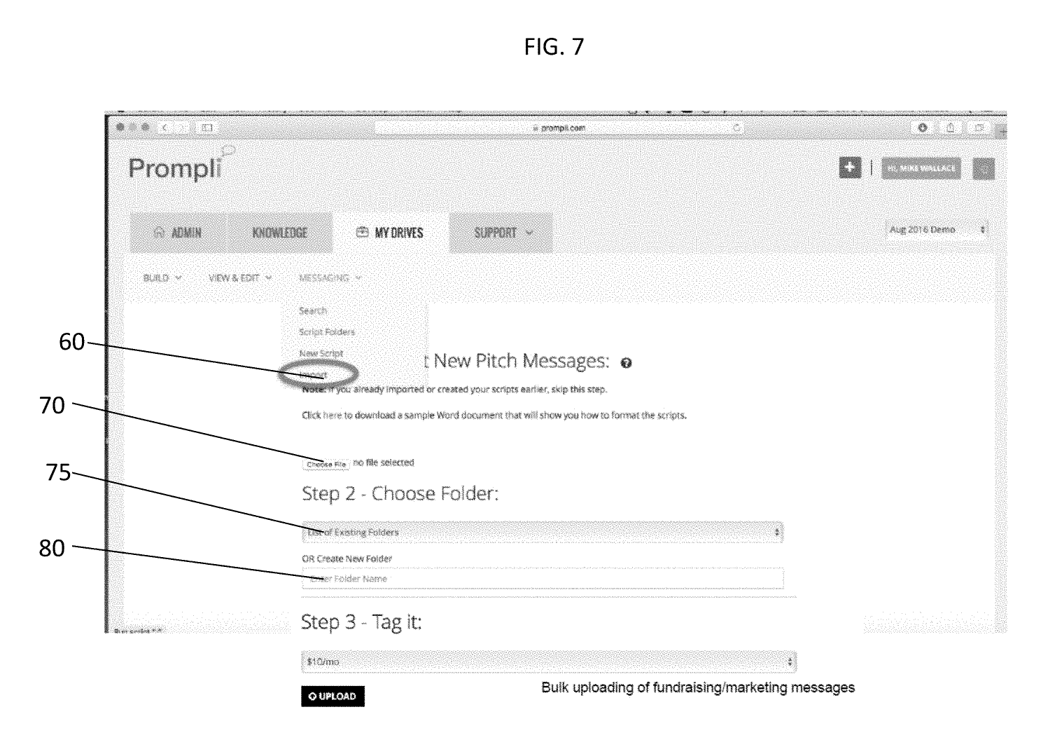

In reference to FIG. 7, a preferred embodiment of the fundraising system is shown, wherein the message uploading page has been accessed by a user. The user is able to import scripts from word documents by selecting the import option 60 from the messaging tab. In the embodiment, the user is then able to import a word document to provide a pitch message for their campaign.

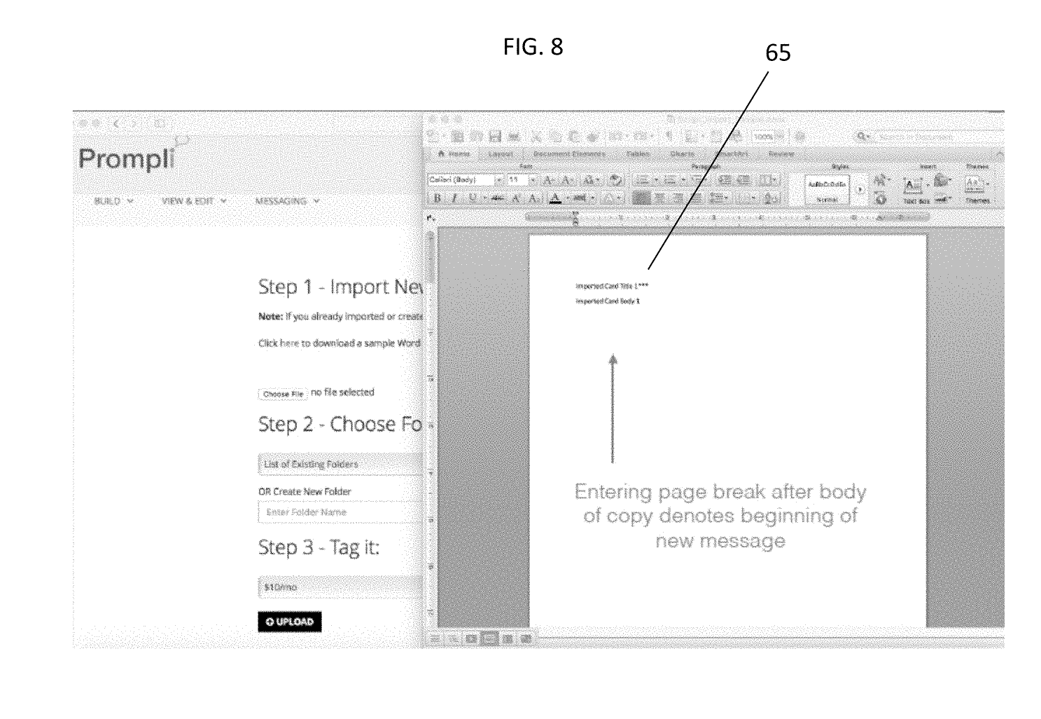

In reference to FIG. 8, an embodiment of the fundraising system is shown, wherein a user is uploading a word document 65 to be used as a pitch message for their fundraising campaign. In the preferred embodiment, the uploader uses common key strokes to enable multiple messages to be uploaded at one time. In the preferred embodiment, text followed by three asterisks (***) in a row denote the title of the pitch message. In other embodiments, the title of a pitch message may be denoted by bolding, underlining, or other methods deemed suitable. Furthermore, a line break after the three asterisks denotes the body of the text. In the preferred embodiment, a page break denotes the beginning of a new pitch message.

Again, with reference to FIG. 7, once the user has created a word document with one or more pitch messages in the proper format, the user may select the choose file button 70. After selecting the choose file button, a file explorer window will be presented enabling the user to choose the word document containing their desired pitch messages. In the preferred embodiment, the user will then be able to place their messages in a folder by selecting an existing folder from the folder drop down menu 75. The user may also create a new folder by entering a name into the create new folder field 80.

In the preferred embodiment, if a new folder is to be created, the user must select a content tag from the tag drop down menu 85. The content tag denotes the content of the message for analytical purposes. The content tags are universal across the fundraising system, and all users are given are provided with the same content tags to select from.

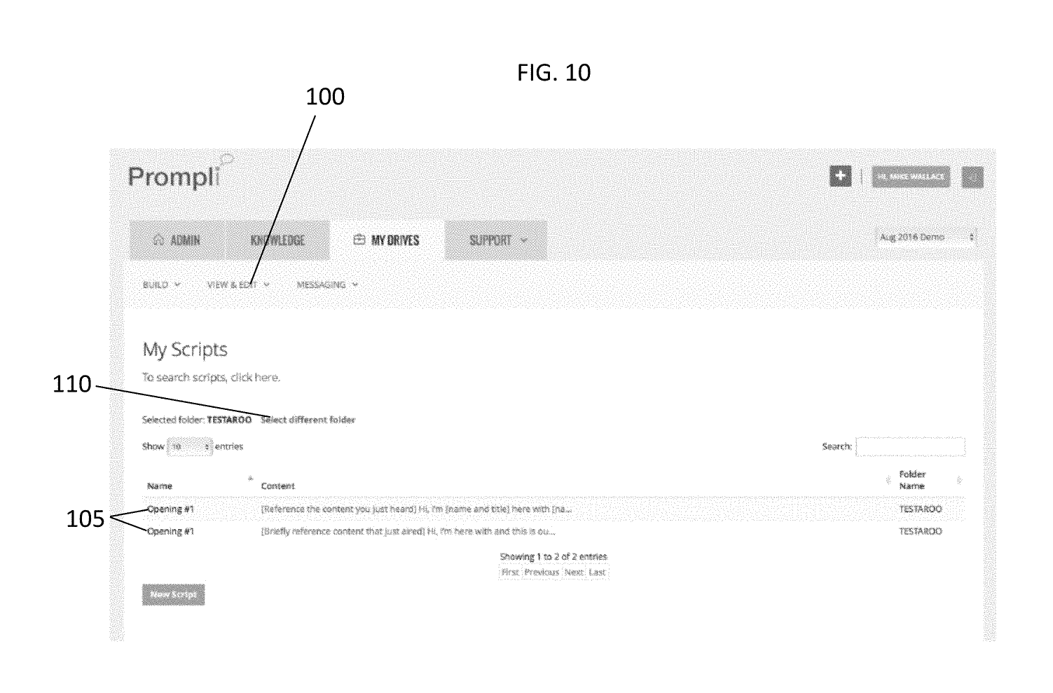

When the user is ready to upload their fundraising or marketing messages, they will select the upload button 90. This uploads their messages to their campaign. In the preferred embodiment, the user will be provided with a successful upload message, as shown in FIG. 10.

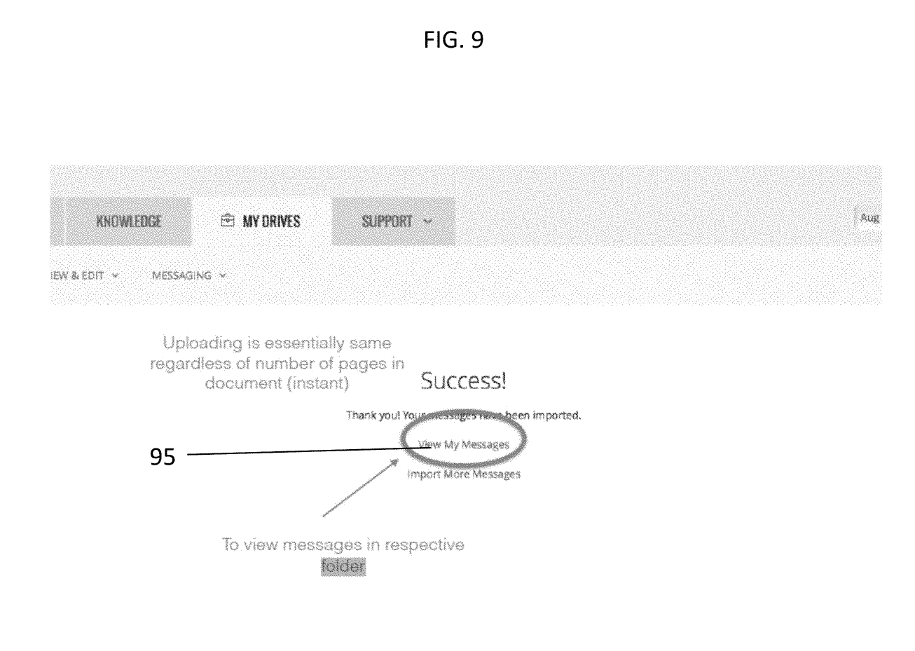

In reference to FIG. 10, the “My Scripts” page is shown, according to an embodiment of the present invention. The “My Scripts” page may be accessed by a user selecting the “View My Messages” link (95 shown in FIG. 9) or by selecting “View Messages” from the “View & Edit” menu 100. In the preferred embodiment, the “My Scripts” page displays information of current messages 105 of a selected folder. The user is able to select a different message folder by selecting the “Select Different folder” link 110.

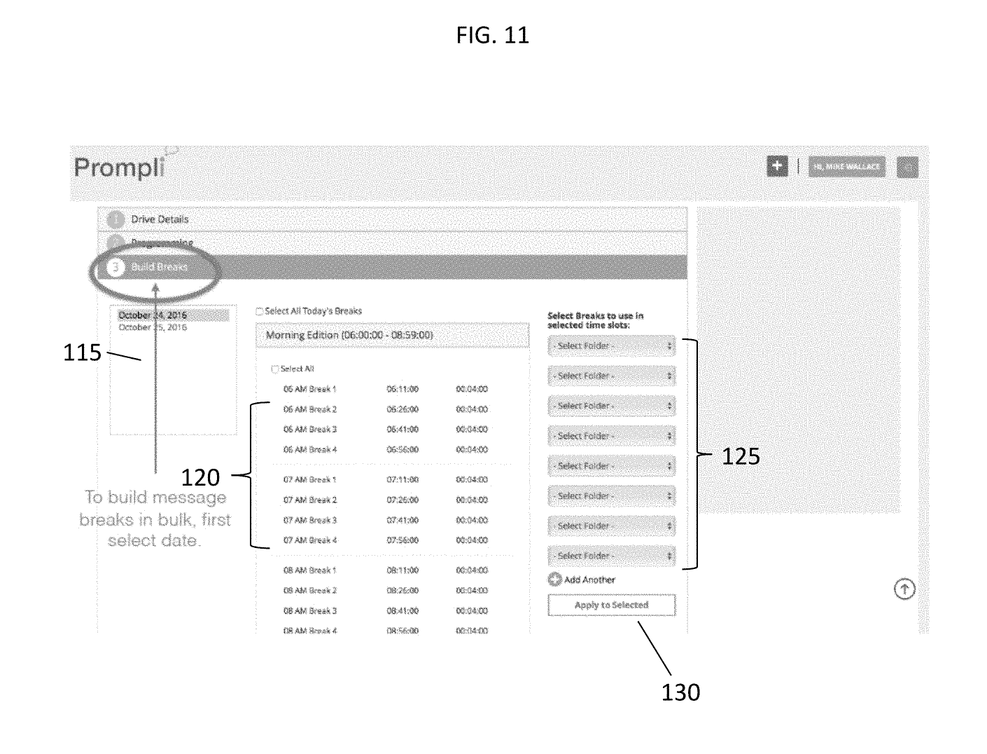

In reference to FIG. 11, the “Build Breaks” page is shown, according to an embodiment of the present invention. On the “Build Breaks” page, the user is able to schedule messages to be posted for the campaign. In the embodiment, the user first selects a date to schedule messages from the date box 115. The user then selects which time of day they wish to schedule the breads from the break schedule 120, and selects the message folder from the “Select Folder” drop down menus 125. In the preferred embodiment, the user selects the message folders in the desired sequence to be displayed. One the sequence is selected, the user selects the “Apply to Selected” button 130 and a message from each folder is scheduled, in sequence, until all breaks have been filled. This method quickly fills all of the breaks with messages, as opposed to having to select a message for each break.

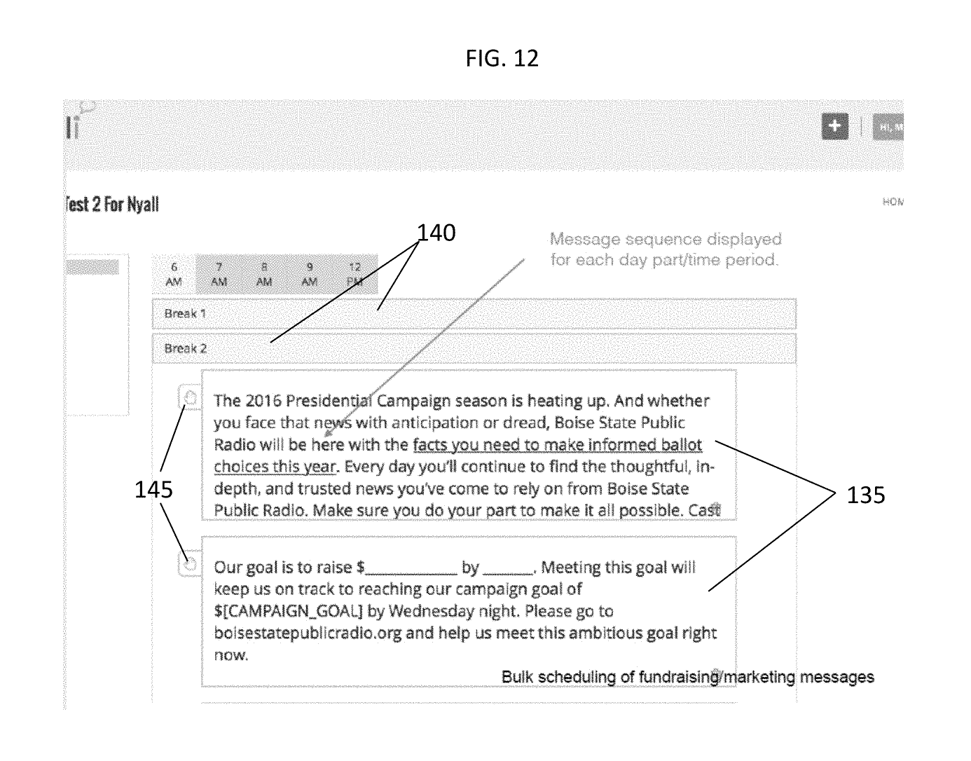

In reference to FIG. 12, an embodiment of the present invention is shown wherein the uploaded and scheduled campaign messages 135 are displayed to the user. The messages are displayed for each break 140, and the messages 135 can be rearranged into the desired sequence by clicking and dragging the hand icons 145.

In the preferred embodiment, the messages 135 are to be read over the radio during the assigned break 140. Contributions or donations are given after the message is read, but prior to the next message, can be attributed to that particular message. The donations can be used as a metric to measure the success of the message. In the pursuit of an efficient campaign message, a user could choose to send out similar messages with slight changes in wording, phrasing, or timing. The user can then view the resulting donations using the provided analytical tools to see which messages had the most success. This information can help the user in writing future messages.

In another embodiment, the messages 135 may be electronic and sent through email and social media. Again, contributions or other desired behavioral targets common to consumer marketing can be attributed to the message or email which was most recently sent or posted to give the user insight on what makes a campaign message successful. The user may also look at analytics based on location to determine if particular message structures are more successful in bringing in donations in certain areas. The user may then choose to restructure appeals based on messaging which appears to be most effective. This could be done in near-real time by the user, or to help inform future appeals, depending on the requirements of the campaign.

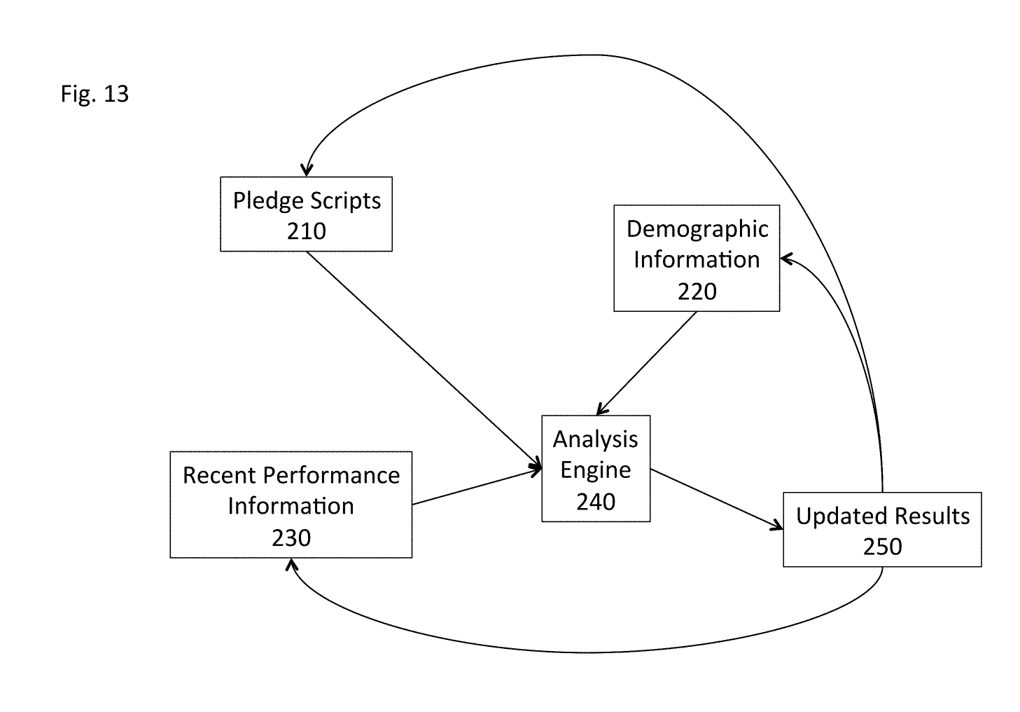

FIG. 13 illustrates an embodiment of a system which may incorporate the present invention. Initially pledge scripts 210 or other advertising material is used, in conjunction with demographic information 220 and performance information 230. Analysis engine 240 determines which pledge scripts are providing actual payments or pledges of payments through updated results 250. Analysis engine then reorganizes pledge scripts 210 to enhance revenue, resulting in measurable increases in payments.

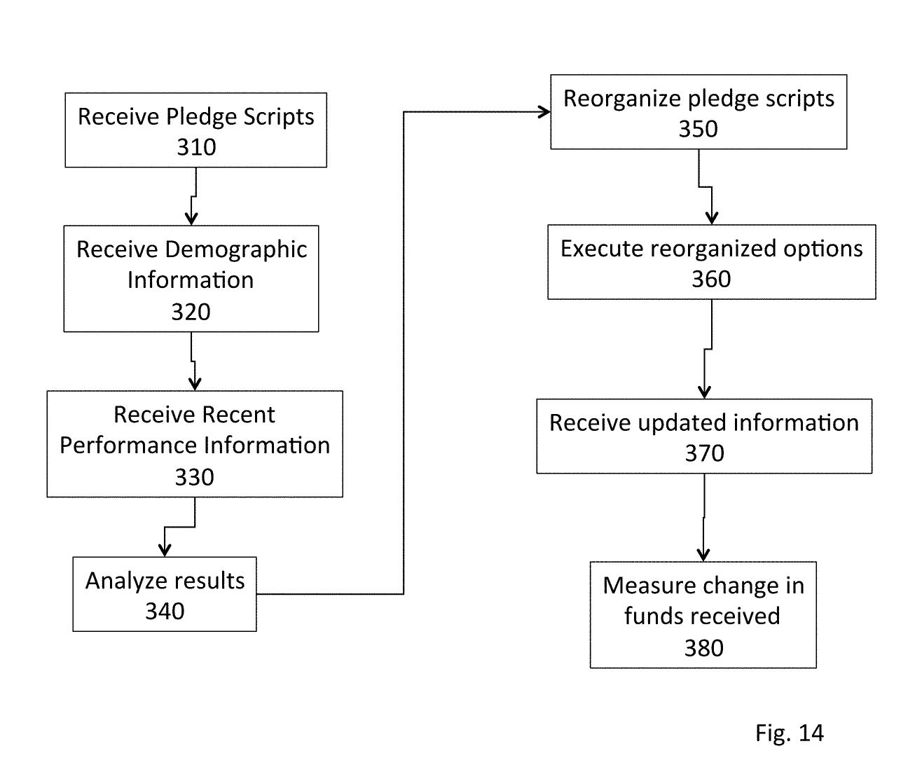

FIG. 14 illustrates an embodiment of a process of updating pledge scripts and revising pledge scripts responsive to results of payments.

The invention has been described herein using specific embodiments for the purposes of illustration only. It will be readily apparent to one of ordinary skill in the art, however, that the principles of the invention can be embodied in other ways such as fundraising and consumer marketing through email, social media and internet video streaming. Therefore, the invention should not be regarded as being limited in scope to the specific embodiments disclosed herein.

1. A web-based analytic system comprising:
a. a message scheduler;
b. a donation stream having;
wherein each donation of the donation stream is provided with a time stamp, and wherein the time stamp correlates with a scheduled message from the message scheduler.
